(19) United States
(12) Patent Application Publication
(10) Pub. No.: US 2014/0145584 A1
(43) Pub. Date: May 29, 2014

(54) HEMISPHERICAL REMOTER PHOSPHOR AND METHODS OF FORMING THE SAME

(71) Applicant: AVAGO TECHNOLOGIES GENERAL IP (SINGAPORE) PTE., Singapore (SG)

(72) Inventors: Sook Choo Lim, Penang (MY); Yean Chon Yaw, Penang (MY); Kit Lai Wong, Penang (MY)

(73) Assignee: Avago Technologies General IP (Singapore) Pte. Ltd., Singapore (SG)

(21) Appl. No.: 13/686,912

(22) Filed: Nov. 27, 2012

(51) Int. Cl. H05B 33/14; H05B 33/10

(52) U.S. Cl. CPC H05B 33/145; H05B 33/10
USPC 313/503; 445/58

(57) ABSTRACT

An illumination device is disclosed. The illumination device includes a light source and a remoter phosphor configured to alter the color of light emitted by the light source. The remoter phosphor is provided with a substantially hemispherical shape that substantially corresponds to a radiation pattern of the light source, which helps to reduce or eliminate the occurrence of the yellow ring phenomenon, among other things. Methods of manufacturing an illumination device are also disclosed.

### FIELD OF THE DISCLOSURE

The present disclosure is generally directed toward light emitting devices and packages for the same.

### BACKGROUND

Light Emitting Diodes (LEDs) have many advantages over conventional light sources, such as incandescent, halogen and fluorescent lamps. These advantages include longer operating life, lower power consumption, and smaller size. Consequently, conventional light sources are increasingly being replaced with LEDs in traditional lighting applications. As an example, LEDs are currently being used in flashlights, camera flashes, traffic signal lights, automotive taillights and display devices.

Two prevalent types of LED form factors are surface-mount LEDs and thru-hole LEDs. Surface-mount LEDs are particularly well suited for applications that require a low device height whereas thru-hole LEDs are better suited for focusing/directing light (e.g., for narrow viewing angle applications). Conventional thru-hole white lamps have been negatively affected by what is known as the yellow ring phenomenon. This phenomenon occurs because of the different phosphor concentration and phosphor thickness deposited inside the reflector cup and results in a ‘yellow’ ring that is observed during off axis viewing.

Another disadvantage to conventional thru-hole white lamps is that the phosphor degrades due to the operating conditions imposed on the phosphor. Specifically, the blue LED die(s) used for the lamp are known to generate significant heat during operation. The heat generated by the LED die(s) creates a high temperature environment about the phosphor, which causes the phosphor to degrade more rapidly than if it were exposed to lower operating temperatures.

Yet another disadvantage is that the wires connecting the LED die(s) to the leads of the lamp are prone to breaking, cracking, or the like. In particular, a mismatch of coefficient of thermal expansion between the phosphor mixture and the clear epoxy encapsulation used for most white lamps causes the wire to shrink and expand in different scales across the two materials. This shrinking and expansion places stresses on the wire, often resulting in a broken wire.

### SUMMARY

It is, therefore, one aspect of the present disclosure to provide an illumination device that overcomes the above-noted shortcomings. In particular, embodiments of the present disclosure introduce an inverted sedimentation process to create a remoter phosphor into the conventional thru-hole white lamp. The sedimentation process described herein creates a remoter phosphor in a substantially hemispherical shape. The substantially hemispherical remoter phosphor can help to (1) improve or eliminate the yellow ring phenomenon, (2) minimize phosphor degradation in high temperature environments, and (3) eliminate wire breakage due.

In accordance with at least some embodiments, an illumination device is provided that includes a phosphor material that has been allowed to naturally separate into a first phosphor portion and a second phosphor portion. The first phosphor portion may correspond to a phosphor sediment portion while the second phosphor portion may correspond to phosphor that is substantially devoid of phosphor sediment.

In some embodiments, it may be possible to control or otherwise manipulate the staging time required for a phosphor sedimentation/separation process to occur. Staging time, as used herein, refers to the waiting time of a phosphor mixture to go through a sedimentation process before it goes into the oven for curing. It should be appreciated that the staging time should not be too long as the epoxy mixture has its own pot life to be considered. Thus, the sedimentation is judged according to the ratio between the sedimentation phosphor height to reflector cup depth. In some embodiments, the ratio is approximately ⅓ but it depends on the phosphor characteristic. If the phosphor has a relatively high efficiency (e.g., the ratio is approximately less than ⅓), then it may be possible to control the sedimentation process to achieve a desired brightness and color point.

Electrically-conductive components of the illumination device including the light source, bonding wires, and leads may be positioned in the phosphor material such that they are not in contact with the first phosphor portion. Moreover, the sedimentation process described herein may result in the first phosphor portion having a substantially hemispherical shape, which helps to produce an even light distribution from the illumination device, thereby creating better color uniformity.

A substantially hemispherical first phosphor portion provides several advantages. As one example, it provides consistency to color point fraction. In some embodiments, the first phosphor portion may comprise a concentration that is high at the center of the structure and low at its sides. Thus, the yellow light energy distribution is mapped to blue light energy distribution from the blue light source, which may also be focused at the center. The result of forming the first phosphor portion to correspond to the radiation pattern of the light source is better color uniformity and a reduction or elimination of the yellow ring traditionally associated with white LED lamps.

Another advantage of the present disclosure is that by establishing a predetermined buffer or distance between the first phosphor portion and the light source helps to reduce the amount of heat imparted on the phosphor. If the amount of heat imparted on the phosphor is minimized, the degradation of the phosphor is minimized, thereby increasing the quality and shelf life of the illumination device.

Another advantage of the present disclosure is that the entirety of the wire(s) that bond the light source to the lead(s) can be completely encapsulated in a single material. Having the wire(s) be completely encapsulated in a single material eliminates the thermal expansion mismatch and, therefore, reduces the stresses imparted on the wire.

A method of manufacturing an illumination device is also provided. The method includes a step where the phosphor material is allowed to settle away from the light source and other electrically-conductive components. In particular, an inverted sedimentation process is described which not only creates a remoter phosphor layer, but the remoter phosphor layer comprises a substantially hemispherical shape that helps improve the overall quality of light emitted by the illumination device.

The present disclosure will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is a cross-sectional view of an illumination device in accordance with embodiments of the present disclosure;

FIG. 2A is a cross-sectional view of a mold cup and phosphor material in accordance with embodiments of the present disclosure;

FIG. 2B is a cross-sectional view of electronics configured to be incorporated into an illumination device in accordance with embodiments of the present disclosure;

FIG. 2C depicts a first series of manufacturing steps in accordance with embodiments of the present disclosure;

FIG. 2D depicts a second series of manufacturing steps in accordance with embodiments of the present disclosure; and

FIG. 3 is a flow chart depicting a method of manufacturing an illumination device in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Furthermore, although the depicted illumination device corresponds to a thru-hole illumination device, embodiments of the present disclosure are not so limited. It should be appreciated that embodiments of the present disclosure may be applied to non-thru-hole illumination devices, such as surface mount devices and the like. The description of the thru-hole illumination device is

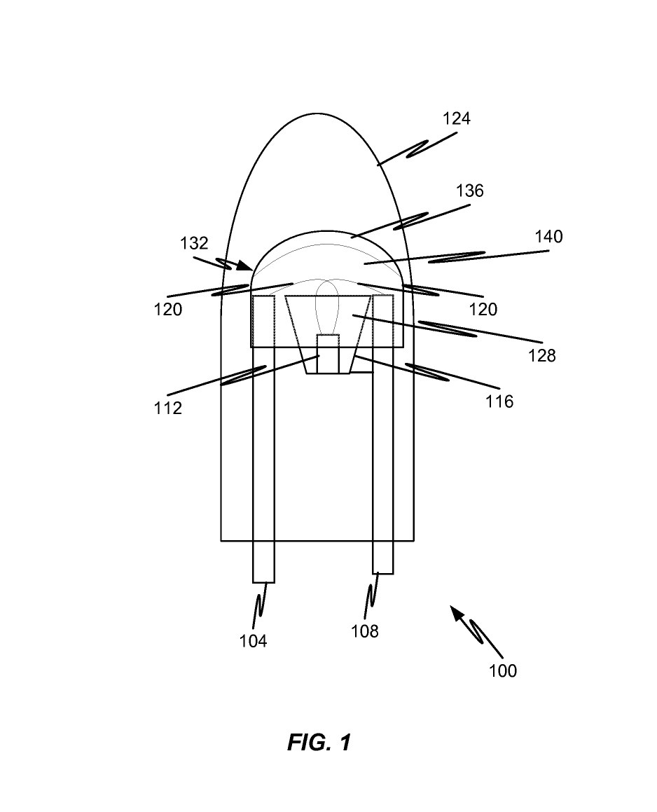

With reference now to FIG. 1, details of an illustrative illumination device 100 will be described in accordance with at least some embodiments of the present disclosure. The illumination device 100 may include a first lead 104 and second lead 108 that enable the illumination device 100 to be mounted in a thru-hole fashion to a Printed Circuit Board (PCB) or similar type of substrate that supports electronics. In some embodiments, the first lead 104 and second lead 108 are constructed of a conductive material such as metal, a conductive polymer, and/or a conductive composite. More specific examples of materials that may be used for the leads 104, 108 include, without limitation, lead, aluminum, copper, gold, silver, etc. In some embodiments, the leads 104, 108 comprise a substantially cylindrical or tubular shape and can be inserted into a hole on a PCB, for instance.

The leads 104, 108 may be partially encapsulated by an encapsulant 124 that protects the other electrically-conductive components of the illumination device 100. However, to facilitate mounting of the illumination device 100, at least some portion of the leads 104, 108 may be exposed outside of the encapsulant 124.

The other electrically-conductive components of the illumination device 100 may include one or more bonding wires 120 and a light source 112. In some embodiments, a structure is physically attached to one of the first lead 104 and second lead 108 to physically support the light source 112. In some embodiments, a reflector cup 116 may be physically attached to or integrated with one of the first lead 104 and second lead 108 and the reflector cup 116 may be used to physically support the light source 112. In more specific embodiments, the reflector cup 116 may comprise a substantially reflective material that may or may not be conductive. The reflector cup 116 may be shaped to help direct light emitted by the light source 112 toward a predetermined location (e.g., upward in the example depicted in FIG. 1). Even more specifically, the reflector cup 116 may comprise a particular shape that is used to maintain the light emission of the illumination device 100 within a predetermined angle (e.g., a particular viewing angle). As a non-limiting example, the reflector cup 116 may comprise a substantially conical shape that extends outwardly.

As noted above, the walls of the reflector cup 116 may comprise a reflective property that enables reflection of light emitted by the light source 112. In some embodiments, the walls of the reflector cup 116 may be made of a reflective material (e.g., metal, white polymer, etc.) or the walls of the reflector cup 116 may be coated with a reflective material.

The base of the reflector cup 116 may be configured to receive the light source 112 and, in some embodiments, may enable the light source 112 to be mounted thereto. In particular, the base of the reflector cup 116 may be substantially flat or planar such that the light source 112 can be positioned on the based of the reflector cup 116 and possible mounted or attached thereto. In some embodiments, an adhesive or glue may be used to secure the light source 112 to the base of the reflector cup 116.

In some embodiments, the light source 112 is configured to emit light of a predetermined wavelength or color. More specifically, the light source 112 may be configure to produce and emit light that is approximately blue (e.g., with a wavelength of approximately 450-495 nm). More specifically, the light source 112 may correspond to a Light Emitting Diode (LED) or LED die. The LED die may be configured to emit substantially blue light when current is passed therethrough (e.g., when the LED is activated with current flowing through the leads 104, 108). In the depicted example, the light source 112 corresponds to a blue LED having both its anode and cathode on its top (light-emitting) surface. One known way to manufacture such an LED is by flip-chip manufacturing processes. As a non-limiting example, the anode of the light source 112 may be electrically connected to the first lead 104 via a first bonding wire 120 and the cathode of the light source 112 may be electrically connected to second lead 108 via a second bonding wire 120.

It should be appreciated, however, that a light source 112 having an anode on one surface and a cathode on the opposite surface may also be employed. In such a configuration, one of the anode and cathode may be connected to a lead via a wire 120 while the other of the anode and cathode may be connected to the other lead via conductive properties of the reflector cup 116.

In some embodiments, the reflector cup 116 may be filled with a pre-dip material 128. In some embodiments, the pre-dip material 128 is a kind of epoxy which can withstand a higher temperature as compared to encapsulation epoxy 124. The pre-dip material 128 helps insulate the encapsulation epoxy 124 from heat generated due to light source 112 heat emission and phosphor emission, which would otherwise cause the encapsulation epoxy 124 to rapidly degrade and turn a yellow color. This is one reason why it may not be desirable to use the same material for both pre-dip material 128 and encapsulation epoxy 124.

In some embodiments, the pre-dip material 128 may correspond to or include a resin (e.g., resin A) as well as a hardener or curing agent for the resin (e.g., hardener for resin A). In the depicted embodiment, the pre-dip material 128 may be substantially devoid of phosphor, although embodiments of the present disclosure do contemplate configurations where some type of light-absorbing material may be provided in the pre-dip material 128. In some embodiments, the pre-dip material 128 may completely or substantially completely fill the entirety of the reflector cup 116, at least to a height sufficient to encapsulate the bonds between the wire(s) 120 and the light source 112.

The illumination device 100 may further comprise a phosphor material 132 that encapsulates at least a portion of the electrically-conductive components (e.g., light source 112, wires 120, leads 104, 108, etc.). The phosphor material 132 may be provided to convert the light emitted by the light source 112 from one color into another color, for example by absorbing light of a predetermined frequency. More specifically, the phosphor material 132 may comprise a phosphor powder, a resin (e.g., resin A), and a hardener for the resin (e.g., hardener for resin A). Examples of the types of resin that may be used as resin A include, without limitation, urethane based copolymers and polyester resin based copolymers. The hardeners for the resin may correspond to thermal, ultraviolet, or chemical-based hardeners that, when subjected to the appropriate environment (e.g., heat, light, chemical, etc.) cause the resin to cure or substantially harden. In some embodiments, the resin and the resin hardener provided in the phosphor material 132 may be substantially clear or translucent.

The phosphor component of the phosphor material 132 may correspond to any type of known phosphor or combination of phosphor compounds. More specifically, the phosphor included in the phosphor material 132 may include, without limitation, one or both of a copper-activated zinc sulfide and a silver-activated zinc sulfide (e.g., zinc sulfide silver). The host materials used for the phosphor may include any one or combination of oxides, nitrides and oxynitrides, sulfides, selenides, halides or silicates of zinc, cadmium, manganese, aluminum, silicon, and various rare earth metals. It may also be desirable to include other materials (such as nickel) to quench the afterglow and shorten the decay part of the phosphor emission characteristics. In a very specific, but non-limiting example, the light source 112 may correspond to a blue or ultra-violet-emitting LED and the phosphor material 132 may comprise any material or combination of materials that emit at longer wavelengths than is produced by the light source 112, thereby giving a full spectrum of visible light (e.g., white light).

As can be seen in FIG. 1, embodiments of the present disclosure contemplate the phosphor material 132 being segregated into a first portion 136 and a second portion 140. The first portion 136 of the phosphor material 132 may include phosphor sedimentation (e.g., the particulates or granular components of the phosphor material 132 that have settled during an inverted or force-imposed sedimentation process. The particulates in the first portion 136 of the phosphor material 132 may be between about 5 um and 250 um in diameter.

It should be appreciated that it may not be necessary that the bigger size particle will sediment and the smaller size particle will float. In some embodiments, the sedimentation process is more dependent upon the sequence of events used to treat the phosphor material 132. Specifically, the particle(s) may reach the bottom of a mold first if the particle is first going into the mixture. The last particle added into the mixture will go or not go to sediment is more depend on the concentration and viscosity of the mixture. High concentration mixture will cause the last particle hard to have sedimentation within the staging time. The staging time may be dependent on the pot life of phosphor and the sedimentation phosphor height to cup depth ratio desired. Furthermore, the localized high concentration may cause the phosphor to tabulate at certain areas and thus prevent them to further sedimentation. At the same time, high viscosity of the mixture will also cause the last particle to hardly move under external forces. The localized viscosity may be different from one area to another area. So the sedimentation will be faster at the low viscosity area.

The second portion 140 of the phosphor material 132, on the other hand, is substantially devoid of the phosphor sedimentation (e.g., comprises constituent parts that are approximately less than 5 um in diameter or less than 2.5 um in diameter). This means that most or all of the phosphor material, (e.g., which is heavier than the resin and hardener for the resin) is physically separated from the light source 112 as well as the wires 120. Moreover, the first portion 136 of the phosphor material 132 comprises a substantially hemispherical shape that conforms to the radiation pattern of the light source 112. By separating the first portion 136 of the phosphor material 132 from the light source 112 and wire(s) 120, the degradation of the phosphor can be slowed, the wires 120 are not subjected to unnecessary stresses, and the yellow ring phenomenon typically associated with white lamps can be minimized or avoided.

The entirety of the phosphor material 132 as well as the light source 112, reflector cup 116, and wires 120 may further be encapsulated by the encapsulant 124. In some embodiments, the encapsulant 124 comprises a round or dome shape that provides a light-shaping or light-directing quality. Specifically, the encapsulant 124 may be provided to (1) help shape light emitted by the light source 112 as well as (2) protect the light source 112, wires 120, and other electrically-conductive components.

In some embodiments, the encapsulant 124 is made of a clear or translucent material. More specifically, the encapsulant 124 may include, without limitation, epoxy, silicone, a hybrid of silicone and epoxy, glass, plastic, or combinations thereof. It may also be possible to include phosphor material in the encapsulant 124 without departing from the scope of the present disclosure. Specifically, the encapsulant 124 may comprise phosphor, a hybrid of phosphor and silicone, an amorphous polyamide resin or fluorocarbon, or combinations thereof.

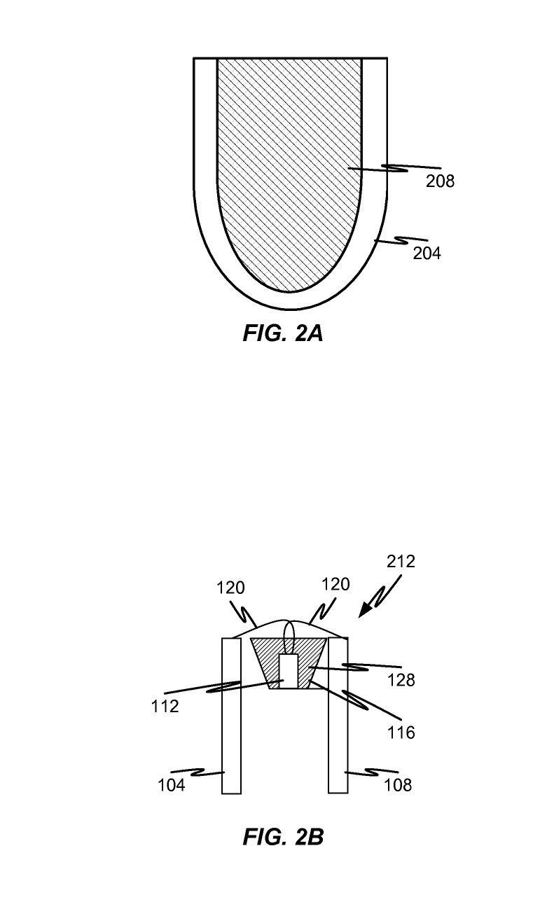

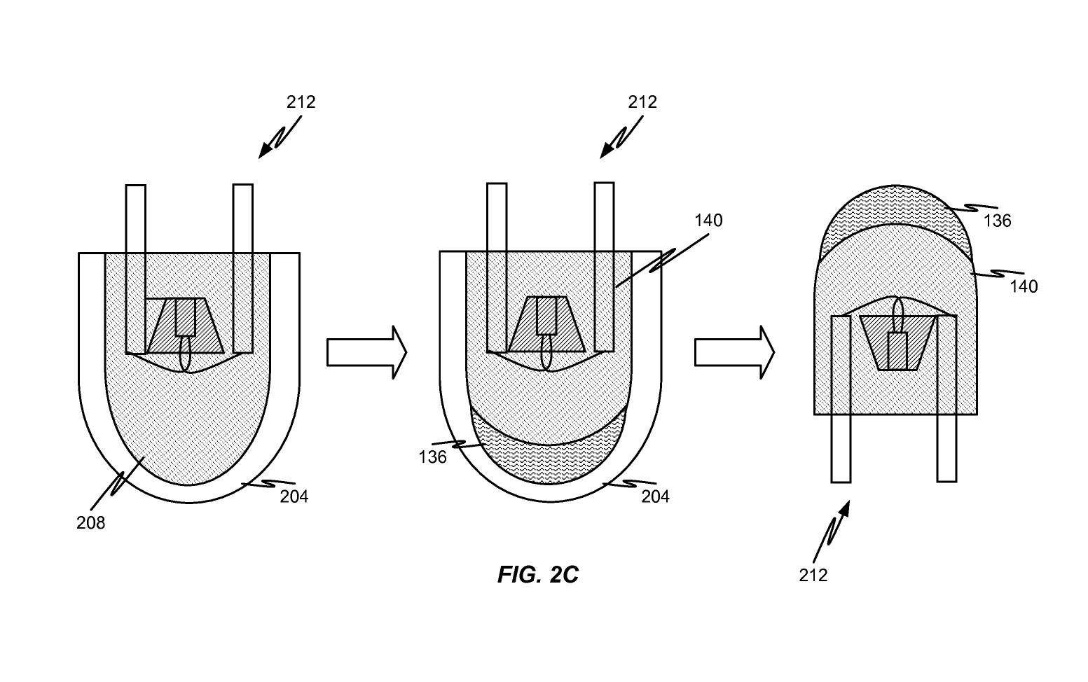

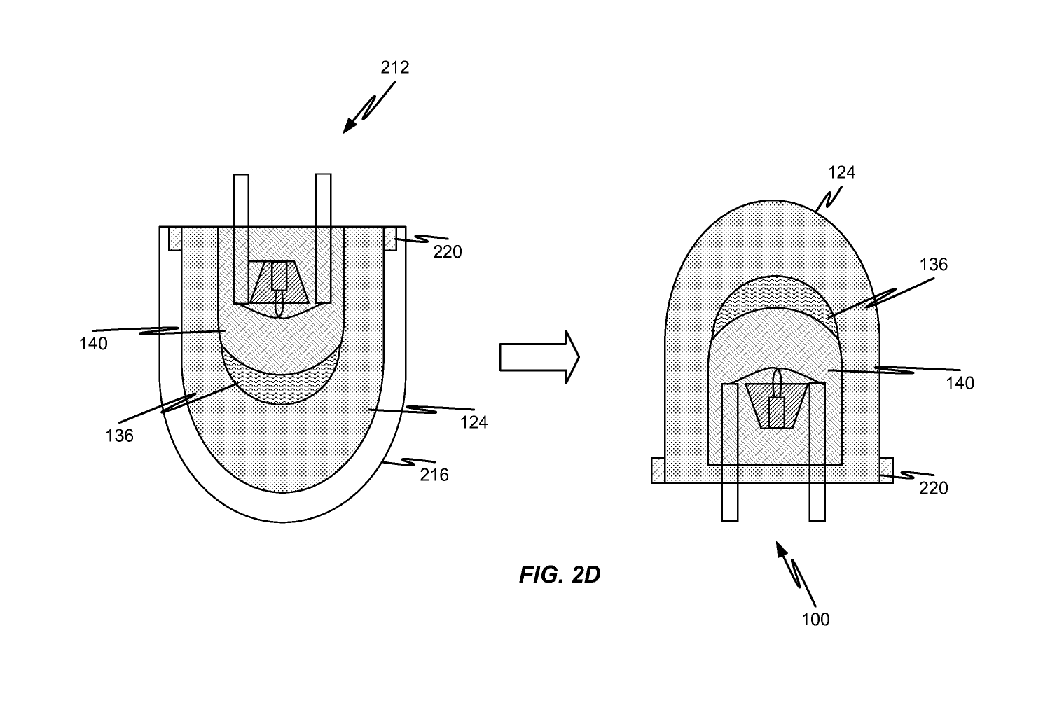

With reference now to FIGS. 2A-D and 3, an illustrative method of manufacturing an illumination device 100 will be described in accordance with at least some embodiments of the present disclosure. Referring initially to FIG. 2A, the method begins by receiving a first mold 204 (step 304). The first mold 204 may dome or cup shaped so that an open end of the mold 204 is capable of being filled with an unsettled phosphor material 208 (e.g., the same or similar material to phosphor material 132) while the closed end of the mold 204 comprises a domed or curved shape to help create the substantially hemispherical first portion 136 of the phosphor material 132.

The method proceeds by filling the first mold 204 with the unsettled phosphor 208 (step 308). In some embodiments, the unsettled phosphor 208 comprises phosphor powder, a resin, and a hardener for the resin that are substantially mixed evenly and dispensed into the first mold 204.

As can be seen in FIG. 2B, electronics 212 or electrically-conductive components may be separately manufactured prior to being inserted into the unsettled phosphor 208. In particular, the leads 104, 108 may be positioned relative to one another, the reflector cup 116 may have the light source 112 mounted therein, the wire(s) 120 may be bonded to the light source 112 and leads 104, 108, and the reflector cup 116 may be filled with the pre-dip material 128. In some embodiments, the pre-dip material 128 comprises a resin and a hardener for the resin, which may be the same resin and resin hardener in the unsettled phosphor 208, but the pre-dip material 128 is substantially devoid of a phosphor.

The electronics 212 may then be dipped into the unsettled phosphor 208 as shown in FIG. 2C (step 312). The phosphor material is then allowed to settle within the staging time and cure inside the oven, for example (step 316) such that the phosphor material naturally separates into a first portion 136 and a second portion 140. In some embodiments, the sedimentation may be facilitated by inverting the electronics 212 in the first mold 204 and allowing gravitational forces to pull the phosphor sedimentation to the closed end of the first mold 204. It should be appreciated, however, that forces other than gravity may be used to facilitate the sedimentation process. For instance, the first mold 204 and the electronics 212 may be placed in a centrifuge or the like and centripetal forces may be employed to facilitate the separation of the phosphor material into first and second portions. Furthermore, embodiments of the present disclosure contemplate that the phosphor sediment may be allowed to settle for a predetermined amount of time (e.g., greater than 5 or 10 minutes) until the resin of the phosphor material is sent for curing (e.g., subjected to a predetermined heat, ultraviolet radiation, etc.)

After the phosphor material has settled and cured, the method proceeds by removing the intermediate device from the first mold 204 (step 320). Thereafter, a second mold 216 may be filled with the encapsulant 124 (step 324). The shape or form of the second mold 216 may be similar to the first mold 204, but the first mold 216 may be larger than the first mold 204. Additionally, the first mold 216 may comprise a feature at its opening that creates a lip 220 with some of the encapsulant 124. The method continues by placing the intermediate device obtained from FIG. 2C into the second mold 216 containing the encapsulant 124 (step 328).

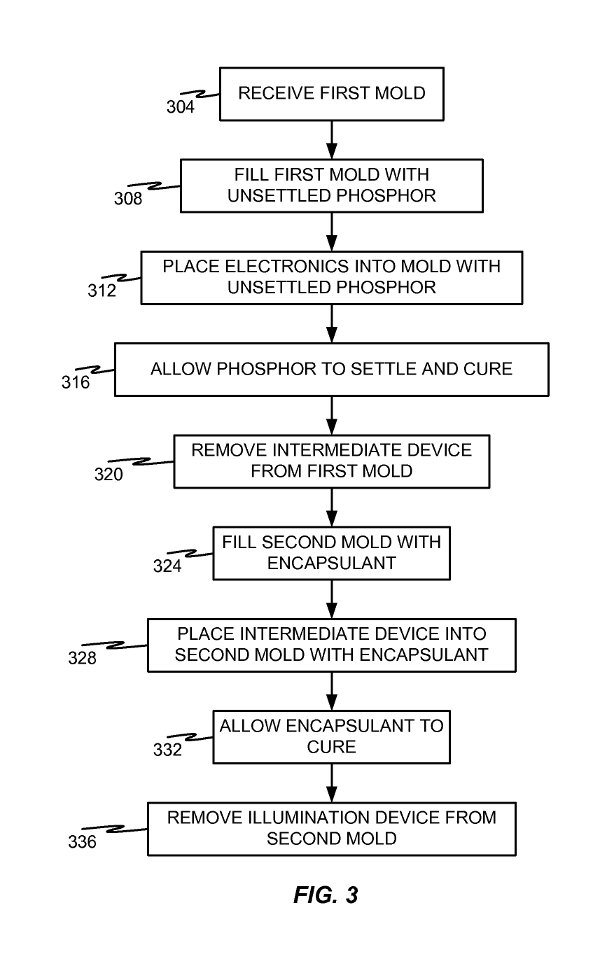

The encapsulant 124 is then allowed to cure (step 332). After the encapsulant has cured, the method proceeds by removing the illumination device 100 from the second mold 216 (step 336). Some additional processing steps that are not depicted in FIG. 3 may then be performed such as singulation, lead trimming, polishing of the encapsulant 124, etc.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

1. An illumination device, comprising:
a light source configured to emit light of a predetermined wavelength;
at least one wire electrically connecting the light source to a lead of the illumination device; and
a phosphor material at least partially encapsulating the light source and at least one wire, wherein the phosphor material is separated into a first portion and a second portion, the first portion of the phosphor material comprising phosphor sedimentation and being physically separated from the light source and at least one wire by the second portion of the phosphor material that is substantially devoid of the phosphor sedimentation.

2. The device of claim 1, further comprising:
a pre-dipping material that is in direct contact with at least a portion of the light source and an area where the at least one wire is connected to the light source, wherein the pre-dipping material does not include phosphor and separates the light source from the phosphor material.

3. The device of claim 2, wherein the pre-dipping material comprises a resin and a hardener for the resin and wherein the second portion of the phosphor material also comprises the resin and the hardener for the resin.

4. The device of claim 3, wherein the pre-dipping material at least partially fills a reflector cup that supports the light source.

5. The device of claim 4, wherein the reflector cup is physically connected to the lead.

6. The device of claim 4, wherein the reflector cup comprises a reflective wall.

7. The device of claim 1, wherein the first portion of the phosphor material is substantially hemispherical in shape.

8. The device of claim 7, wherein the first portion of the phosphor material is thicker at its center than at its ends.

9. The device of claim 1, further comprising:
an encapsulant that substantially encapsulates the phosphor material.

10. The device of claim 9, wherein the encapsulant comprises at least one of epoxy, silicone, a hybrid of silicone and epoxy, glass, and plastic.

11. The device of claim 1, wherein the light source corresponds to a Light Emitting Diode (LED) configured to emit light that is at least one of blue and ultraviolet and wherein the phosphor material emits light at longer wavelengths than is produced by the light source.

12. The device of claim 1, wherein the phosphor material comprises at least one of a copper-activated zinc sulfide and a silver-activated zinc sulfide.

13. The device of claim 1, wherein the lead is configured for thru-hole mounting.

14. An illumination device configured to emit substantially white light, the device comprising:
a Light Emitting Diode (LED) configured to emit light of a predetermined wavelength; and
a phosphor material at least partially encapsulating the LED, wherein the phosphor material is separated into a first portion and a second portion, the first portion of the phosphor material comprising phosphor sediment and being physically separated from the light source by the second portion of the phosphor material that is substantially devoid of the phosphor sediment.

15. The device of claim 14, wherein the predetermined wavelength is greater than or equal to 450 nm.

16. The device of claim 14, wherein the LED comprises an anode and cathode, wherein the anode is connected to a first lead via a first bonding wire, wherein the cathode is connected to a second lead via a second bonding wire, and wherein the first bonding wire and second bonding wire are physically separated from the first portion of the phosphor material by the second portion of the phosphor material.

17. The device of claim 14, wherein the phosphor sediment corresponds to phosphor particulates having a diameter between about 5 um and 250 um.

18. The device of claim 17, wherein the second portion of the phosphor material comprises particulates that are smaller than about 2.5 um in diameter.

19-21. (canceled)

22. The device of claim 1, wherein the predetermined wavelength is greater than or equal to 450 nm.

23. The device of claim 1, wherein the phosphor sedimentation corresponds to phosphor particulates having a diameter between about 5 um and 250 um.

24. The device of claim 23, wherein the second portion of the phosphor material comprises particulates that are smaller than about 2.5 um in diameter.
